(19) United States
(12) Patent Application Publication
(10) Pub. No.: US 2012/0290285 A1
(43) Pub. Date: Nov. 15, 2012

(54) LANGUAGE LEARNING DEVICE FOR EXPANDING VOCABURARY WITH LYRICS

(76) Inventors: Gao-Peng Wang, New Taipei City (TW); Yue-Zhen Mei, Taipei City (TW)

(21) Appl. No.: 13/103,974

(22) Filed: May 9, 2011

(51) Int. Cl. G06F 17/28

(52) U.S. Cl. 704/2

(57) ABSTRACT

A language learning device for expanding vocabulary with lyrics have a learning platform selected from information network, a personal computer, an electronic dictionary apparatus, a multimedia apparatus, a personal digital assistant (PDA), a cell phone, a paper sheet, a book, a memory card, and an optical disk. The learning platform further comprises an original lyric data base, a translated lyric data base, a word group expansion data base, and a correlated short sentence data base. The words of the original lyrics appear in order to match short sentences formed with the original word groups and the translated word meanings in the second language for learning a batch of expanded words. The language learning device is capable of being applied to assisting trilingual and even multilingual learning in addition to the bilingual learning.

### BACKGROUND OF THE INVENTION

1. Field of the Invention

The present invention relates to a language learning device, and, more particularly, to a language learning device with original lyrics of songs for expanding bilingual, trilingual and multilingual vocabularies in batches.

2. Description of Related Art

There are many ways for learning languages such as association method for memorizing vocabulary, seeing movies for learning foreign languages, root-prefix-etymology method, words-logical-memory method, singing for learning English, dismantling syllable and image memory method, chatting with foreigners, . . . , and etc. Basically, each of the preceding method has its advantage and disadvantages.

For instance, singing songs for learning English is really a way capable of obtaining good performance. To cram up a paragraph is laborious and it is easy to be forgotten. A verse of an elegant lyric has a series of words emerging in order with a pleasing melody is easy for the singer to unforgettably memorize the lyric in short time. However, it is flying in the Ointment that the vocabulary in each lyric is very limited while conventional singing songs for learning English are used.

Besides, words-logical-memory method takes each word as a unit to expand more recited words via adding or deleting prefixes or suffixes; but the deficiency of this method is in that it has to have related data at hand for comparison when the simple expanding memory is applied, otherwise, it is lack of coherence between words due to the basic words being arranged without considering timing, and translations of the related expanded words are lack of coherence to each other as well. Therefore, the words are incapable of being associated and memorized conveniently as the association method.

In addition, although developments regarding related computer aided instructions have made progress greatly since twentieth century, and it not only breakthroughs the way of using paper sheets to build diversification of the learning platform but also develops more efficient learning systems and methods in net generation, a learning system, which is capable of effectively integrating sequence of appearing the words with expansion of vocabulary, has not been proposed ever before.

### SUMMARY OF THE INVENTION

In order to overcome the deficiencies of the conventional language learning systems or methods, a language learning device for expanding vocabulary with lyrics is proposed, and the language learning device comprises:
a learning platform selected from information network, a personal computer, an electronic dictionary apparatus, a multimedia apparatus, a personal digital assistant (PDA), a cell phone, a paper sheet, a book, a memory card, and an optical disk, and the learning platform further comprising:
an original lyric data base having a plurality of original lyrics in a first language, each of the original lyrics corresponding to a music, and containing a plurality of original expressions, and each of the original expressions consisting of a plurality of words having a first common word form with a first local position;
a translated lyric data base having a plurality of translated lyrics in a second language corresponding to the original lyrics;
a word group expansion data base having a plurality of original word groups and a plurality of word meanings in the second language, each of the original word groups having a second common word form with a second local position identically corresponding to the first word form with the first local position; and
a correlated short sentence data base having a plurality of translated short sentences in the second language corresponding to the original word groups;
whereby, the words of the original lyrics appear in order to match short sentences formed with the original word groups and the translated second language word meanings for learning a batch of expanded words.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of a language learning device according to the present invention;

FIG. 2 is a block diagram illustrating the language learning device of the present invention being integrated to data bases;

FIG. 3 is a block diagram illustrating the first preferred embodiment of the language learning device according to the present invention;

FIG. 4 is a block diagram illustrating the first preferred embodiment of the language learning device according to the present invention;

FIG. 5 is a block diagram of the integrated data bases of the language learning device according to the present invention in which software with a multilingual function being provided additionally;

FIG. 6 is a block diagram illustrating a preferred embodiment of the language learning device according to the present invention for multilingual learning.

### DETAILED DESCRIPTION OF THE INVENTION

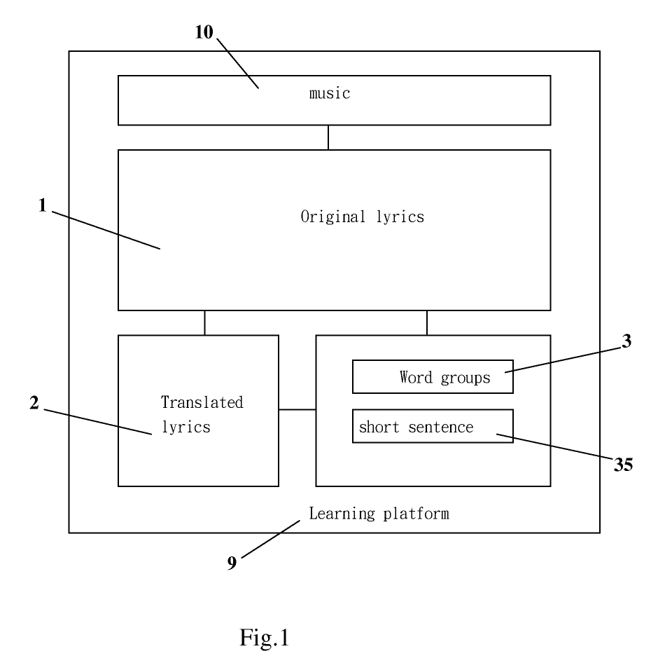

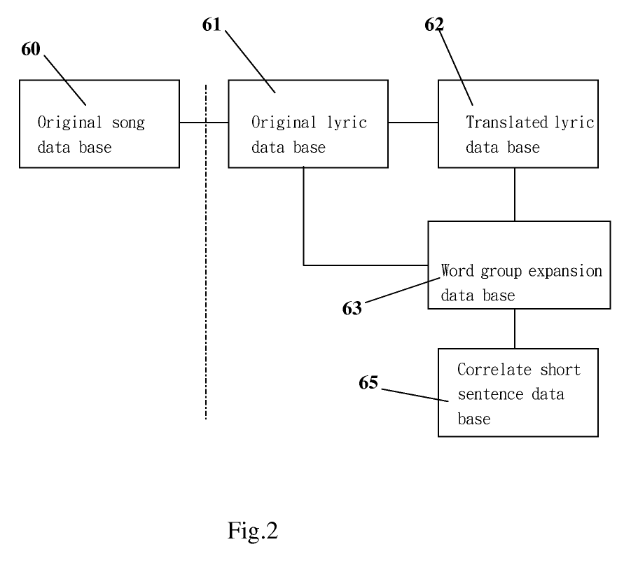

Referring to FIGS. 1 to 3, a language learning device for expanding vocabulary with lyrics in accordance with the present invention comprises a learning platform 9 selected from information network, a personal computer, an electronic dictionary apparatus, a multimedia apparatus, a personal digital assistant (PDA), a cell phone, a paper sheet, a book, a memory card, and an optical disk; the learning platform 9 is provided with an original lyric data base 61, a translated lyric data base 62, a word group expansion data base 63, and a correlated short sentence data base 65, wherein the original lyric data base 61 corresponds to an original song data base 60 and has a plurality of original lyrics 1 in first language, each of the lyrics 1 contains a plurality of expressions 11, and each of the expressions 11 consists of a plurality of words 12; each of the original lyrics 1 corresponds to a music 10 to form a song in a western language, Japanese, Korean, and Chinese; the translated lyric data base 62 has a plurality of translated lyrics 2 in a second language corresponding to the original lyrics 1; the word group expansion data base 63 has a plurality of original word groups 3 in the first language and translated meanings in second language corresponding to the original word groups 3, and a local position 311 of a common word form of words 31 in the original word group 3 corresponds to a local position 121 of the common word form of the words 12 in the original lyrics 1; the corresponding positions 311, 121 can be prefixes, infixes, or suffixes, and, for instance, “yesterday”, “Monday”, “Tuesday”, “Wednesday”, . . . , and etc. have “day” at the suffixes thereof; the correlated short sentence data base 65 has a plurality of translated short sentences in second language corresponding to the original word groups 3.

The first and second languages are selected from Chinese, English, Japanese, German, Italian, French, Korean, Thai, . . . and etc., or any two languages of the contemporary language families in the world such as English versus Chinese, or Japanese versus Chinese, . . . , and etc.

When the language learning device of the present invention is implemented, famous old songs with elegant words and pleasant melodies, and being familiar to us can be chosen to play repeatedly for the learners capable of practicing the vocabulary in the songs via listening and singing. In fact, it is known that the final performance of learning language is closely related to how many of the vocabulary being memorized regardless what method is applied, and it is very important that how to use trivial time properly in addition to having a right way for learning such that learning can be involved in our daily lives and practiced unceasingly, and it will be successful in time.

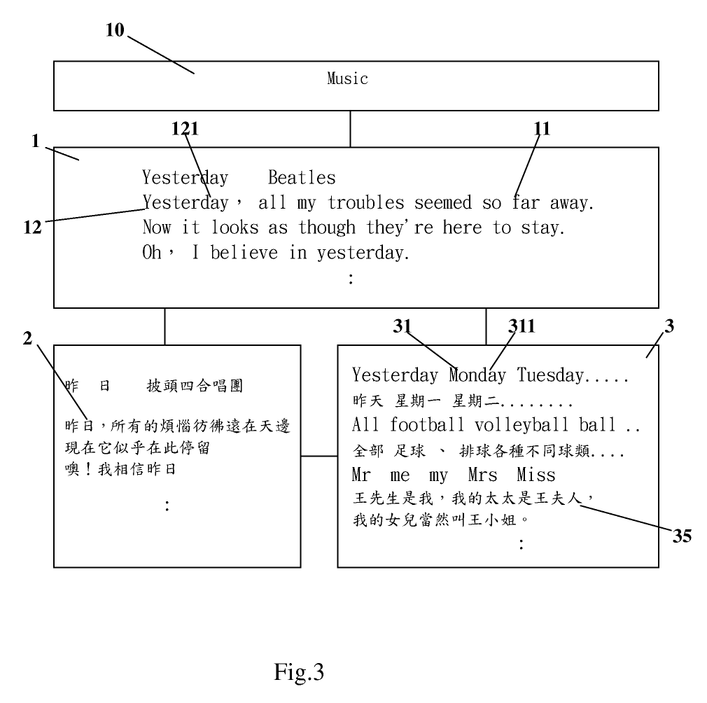

Referring to FIG. 3, the English old song “Yesterday” with bilingual English-Chinese is taken as an exemplary example. If the original lyrics 1 are counted with WORD software automatically, the total number of the original words is 84 including repeated words (part of the original lyrics 1 are shown in FIG. 3), and it is equivalent to the maximum amount of the conventional singing way for learning the words 12. When the language device according to the present invention is applied, words 12 in the original lyrics 1 are capable of being utilized for expanding vocabulary effectively, and providing good relations with each other between words 12; in this way, the words 12 can be associated and memorized easily as they are listed hereinafter:
Yesterday, all my troubles seemed so far away.
Now it looks as though they're here to stay.
Oh, I believe in yesterday.

Verse one of the original lyrics 1 in the old song “Yesterday” has 22 words after being counted with WORD software automatically, and it is capable of being expanded to 102 words effectively when the language learning device of the present invention is applied. In order to explain conveniently, counted number of the words is placed at the first position and the word groups 3 are placed afterward in the first section; the translated Chinese correlative short sentences 35 are listed in the second section. The corresponding words in the two sections are positioned identically in sequence and shown in bold italics for being compared easily.

13. day today yesterday Monday Tuesday Wednesday Thursday Friday

[symbol]

, [symbol] [symbol] , [symbol] , [symbol] ,

[symbol]

14. hall tall wall waterfall basketball baseball football volleyball ball overall call shall all fall.

[symbol]

, [symbol] [symbol] , [symbol] [symbol] [symbol] [symbol] , [symbol] , [symbol] [symbol] ,

[symbol]

[symbol]

5. Mr me my Mrs Miss

[symbol]

, [symbol] ,

[symbol]

[symbol]

5. bubble double noble possible trouble.

[symbol]

[symbol]

, [symbol] [symbol] , [symbol] [symbol] ,

[symbol]

[symbol]

[symbol]

[symbol]

3. seem deem teem.

[symbol]

[symbol]

,

[symbol]

[symbol]

8. son sox sod sow soy sop so sob.

[symbol]

[symbol]

, [symbol] [symbol] , [symbol] ,

[symbol]

[symbol]

[symbol]

3. fat fan far.

[symbol]

, [symbol] , [symbol] [symbol] , [symbol] [symbol] ,

[symbol]

7. anyway away freeway highway subway railway sway.

[symbol]

[symbol]

, [symbol] [symbol] , [symbol] , [symbol] [symbol] [symbol] , [symbol] , [symbol] [symbol] ,

[symbol]

[symbol]

3. know now snow.

[symbol]

[symbol]

,

[symbol]

[symbol]

9. cook took crook brook hook book look notebook textbook.

[symbol]

[symbol]

, [symbol] , [symbol] [symbol] [symbol] ,

[symbol]

[symbol]

[symbol]

2. as gas.

[symbol]

[symbol]

6. though rough bough through tough cough.

[symbol]

[symbol]

, [symbol] [symbol] , [symbol] , [symbol] [symbol] , [symbol] [symbol] , [symbol] [symbol] ,

[symbol]

[symbol]

3. they the them.

[symbol]

,

[symbol]

[symbol]

8. here were sphere where there somewhere anywhere everywhere.

[symbol]

, [symbol] , [symbol] , [symbol] , [symbol] [symbol] ,

[symbol]

7. toy top ton toe too to tow.

[symbol]

[symbol]

, [symbol] 10 [symbol] , [symbol] 10 [symbol] ,

[symbol]

[symbol]

[symbol]

3. star stab stay.

[symbol]

, [symbol] ,

[symbol]

[symbol]

[symbol]

3. believe eve grieve.

[symbol]

,

[symbol]

[symbol]

The word group 3 contain total number of the words is 13+14+5+5+3+8+3+7+3+9+2+6+3+8+7+3+3=102, and rhythms of the original music 10 act as timings to correspond to sequence of each of the words 12 of the original lyrics 1 to intensify memorization of the original lyrics 1 and the translated lyrics 2 thereof quickly; Due to the original word group 3 being arranged elaborately, the local positions 311, 121 of the common word form of the words 12, 31 provide identical feature, and a series of key intensifying functions can be generated at the time of the words 31 in the corresponding word group 3 appearing in flocks even if only one or two words in the word group 3 are recognized; in this way, it is easy to substitute differences between the recognized words and unfamiliar words with associations in thinking such that the related expanded words 31 can be learned through recitation; especially, a set intersection of the words 31 in the word group 3 can be induced as a correlated short sentence 35 or an exaggerated story; as a result, it is capable of strengthening impression for associating and reviewing conveniently while in learning such that it is helpful for a great deal of expanded words 31 being memorized speedily.

The principle of the language learning device of the present invention can be explained like that only an egret standing in a bright green paddy field is hard to be found and left an impression; a group of egrets in the same bright green paddy field with different postures and behaviors such as standing, foraging, walking, and flying up provide a vivid scene, and it is easy to be caught the intention and left an impression; by the same token, our brains react the same way while facing external sensory stimulation, that is, a single and prosaic sensory stimulation is less attractive, instead, a group of related sensory stimulations are capable of attracting our attentions and enhancing our memories very much.

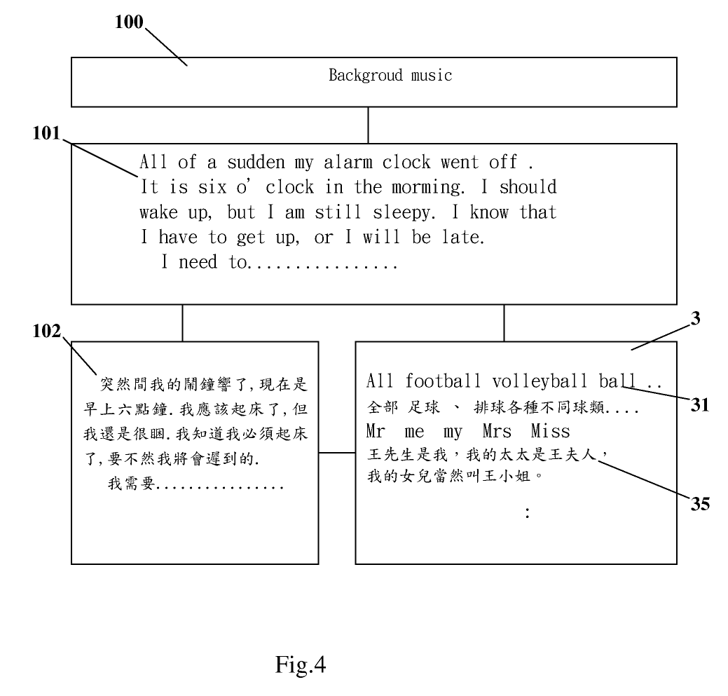

As it has been mentioned above, the language learning device of the present invention can be implemented to recite an article in addition to learning languages via singing; for instance, referring to FIG. 4, a single song or a group of songs composed of a plurality of songs are used as a background music 100 to collocate a short article 101, a translated article 102, an original word group 3, . . . , and etc. such that it can be achieved the object of expanding recognized words with rhythms of the background music 100 as timings for helping recitation. The implementation for recite an article is the same as the way described previously, and no details will be stated further.

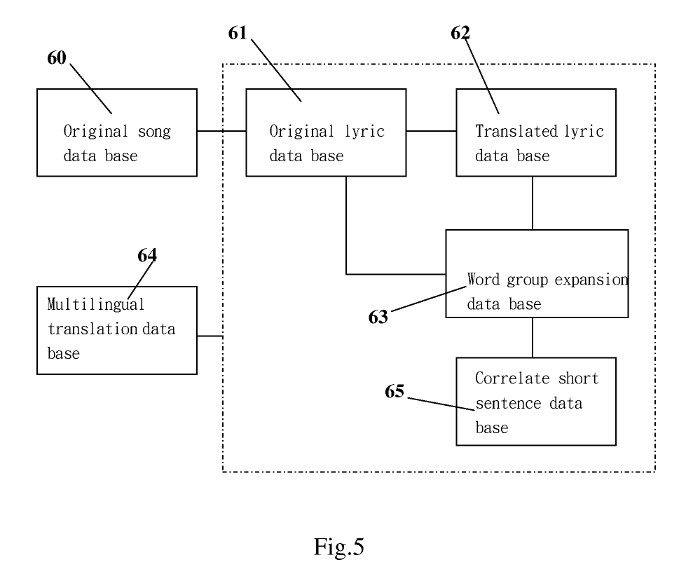

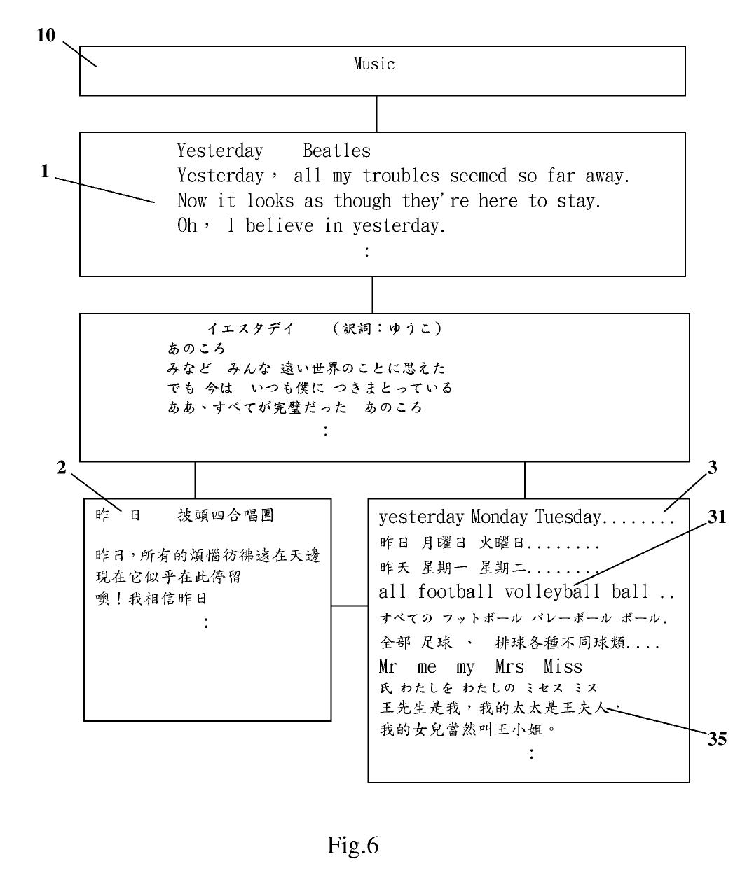

Besides, the language learning device of the present invention can be used for trilingual and even multilingual learning as well in addition to assisting the ordinary bilingual learning. For instance, referring to FIGS. 5 and 6, a multilingual translation data base 64, which contains multilingual data, is provided to correspond to the original lyric data base 61, the translated lyric data base 62, the word group expansion data base 63, and the correlated short sentence data base 65. In this way, the language learning device of the present invention can be applied in the presently popular Chinese teaching system, and the original music 10 in original language such as English is utilized as a medium to assist persons speaking in third language such as Japanese to recognize the second language such as Chinese easily and effectively via the multilingual translation data base 64.

Although the invention has been explained in relation to the preferred embodiments thereof, it is to be understood that many other possible modifications and variations can be made without departing from the spirit and scope of the invention as hereinafter claimed.

What is claimed is:

1. A language learning device for expanding vocabulary with lyrics comprising:
a learning platform selected from information network, a personal computer, an electronic dictionary apparatus, a multimedia apparatus, a personal digital assistant (PDA), a cell phone, a paper sheet, a book, a memory card, and an optical disk, and the learning platform further comprising:
an original lyric data base having a plurality of original lyrics in a first language, each of the original lyrics corresponding to a music, and containing a plurality of original expressions, and each of the original expressions consisting of a plurality of words having a first common word form with a first local position;
a translated lyric data base having a plurality of translated lyrics in a second language corresponding to the original lyrics;
a word group expansion data base having a plurality of original word groups and a plurality of word meanings in the second language, each of the original word groups having a second common word form with a second local position identically corresponding to the first word form with the first local position; and
a correlated short sentence data base having a plurality of translated short sentences in the second language corresponding to the original word groups;
whereby, the words of the original lyrics appear in order to match short sentences formed with the original word groups and the translated second language word meanings for learning a batch of expanded words.

2. The language learning device as defined in claim 1, wherein the learning platform is a book consisting of a plurality of single sheets.

3. The language learning device as defined in claim 1, wherein the identically corresponding first and second positions are prefixes, infixes, or suffixes.

4. The language learning device as defined in claim 3, wherein the first and second languages are selected from Chinese, English, Japanese, German, Italian, French, Korean, and Thai; the music corresponding to each of the original lyrics is a western music, Japanese music, Korean music, or Chinese music.

5. The language learning device as defined in claim 4, wherein the western music is used as a medium for recognizing the first and second languages.

6. The language learning device as defined in claim 4 further comprises a multilingual learning device containing data of a third language in addition to the first and second languages.

7. The language learning device as defined in claim 6, wherein the western music is a medium to help persons speaking the third language to recognize the first and second languages, and the second language is Chinese.

8. The language learning device as defined in claim 1 further comprises an original music data base containing a plurality of original musics corresponding to the original lyrics.

9. The language learning device as defined in claim 1, wherein the learning platform further comprises a multilingual translation data base which contains multilingual data corresponding to original lyric data base, the translated lyric data base, the word group expansion data base, and the correlated short sentence data base.

10. The language learning device as defined in claim 8, wherein the learning platform further comprises a multilingual translation data base which contains multilingual data corresponding to original lyric data base, the translated lyric data base, the word group expansion data base, and the correlated short sentence data base.
